(19) United States
(12) Patent Application Publication
(10) Pub. No.: US 2006/0041881 A1
(43) Pub. Date: Feb. 23, 2006

(54) Universal upgrade architecture

(76) Inventor: Bheema Prakash Adkasthala, Loangmont, CO (US)

Correspondence Address: COATS & BENNETT, PLLC, P O BOX 5, RALEIGH, NC, 27602, US

(21) Appl. No.: 10/921,439

(22) Filed: Aug. 19, 2004

(51) Int. Cl. G06F 9/44

(52) U.S. Cl. 717/168

(57) ABSTRACT

A method of upgrading a wireless communication network node comprises transferring new software modules to the node as needed, saving existing configuration information for the old version of software, and configuring the node for operation with the new version of software using the saved configuration information where appropriate. The upgrade method saves a listing of data instances used by the old software, and saves the actual configuration values for those data instances. Then, the upgrade method configures the node for operation with the software by determining which data instances used in the new version of software had corresponding data instances in the old software, and using the saved configuration information for those data instances. For data instances where reuse of prior configuration data is not possible, or is not desired, the method uses default configuration data, which may be supplied in the form of an upgrade configuration file.

### BACKGROUND OF THE INVENTION

The present invention generally relates to wireless communication networks, and particularly relates to upgrading the software at nodes in such networks.

Networks comprising more than a handful of distributed nodes pose potentially significant software upgrade problems. In particular, upgrading software in the context of wireless communication networks presents significant challenges because of the need to limit network “downtime.” For example, a typical cellular network may be specified to have no more than 60 minutes of downtime per year, which greatly limits the aggregate offline time permissible for upgrading individual network nodes.

Further, the geographic separation between such nodes, and the likelihood of potentially significant configuration differences and software version differences between individual nodes, complicates the task of upgrading them using any kind of uniform approach. For example, a given wireless communication network may include a large number of radio base stations, each one of them including particularized configuration information. Further, different ones of these base stations may run different versions of software, or even different types of software.

In this context, conventional approaches to upgrading the individual nodes strongly depend on the relative differences between the old and new software at each node. Such dependence imposes significant customization requirements on the upgrade framework being used. In other words, the dependence of the upgrade process on node-specific upgrade details thwarts the overarching goal of adopting a uniform approach to the network-wide upgrade process. With existing approaches to upgrading, some node upgrades must be performed by on-site personnel, which completely defeats the goal of carrying out the upgrade process remotely from a centralized network management site.

Of course, one mechanism for implementing a uniformly applicable upgrade process is based on wiping clean each node being configured, so that the variations associated with the particular version of old software running at the nodes is eliminated. However, the advantages gained by the conventional approach to “wiping” nodes in advance of installing new software comes at the expense of lost configuration information. That is, the process of changing the node over to the new software configuration is done without benefit of preserving the node's existing configuration for use in tailoring the newly installed software to the particularized needs of the node.

### SUMMARY OF THE INVENTION

The present invention comprises a method and apparatus providing a “universal” approach to upgrading from old to new software at nodes in a wireless communication network. The upgrade method disclosed herein intelligently retains old configuration information at the node where appropriate, and otherwise uses new, default configuration information.

In one embodiment, the present invention comprises a method of upgrading from old software to new software at a node in a wireless communication network that includes receiving an upgrade configuration file at the node that includes default configuration values for the new software and a list of software modules comprising the new software, initiating transfer of software modules needed at the node for the new software based on the list, and saving snapshot data representing the existing node configuration for the old software. Once the snapshot data is saved, exemplary processing continues with activating the new software at the node, and configuring the node for operation with the new software by carrying forward actual configuration values saved in the snapshot data where appropriate, and otherwise by using default configuration values from the upgrade configuration file.

It should be understood that the method(s) of the present invention can be implemented as a computer program stored in a computer readable medium, wherein the computer program comprises program instructions to carry out the above exemplary upgrade method. The computer readable medium may comprise memory or other electronic storage at the node to be upgraded, and the computer program, referred to as an “upgrade management program” herein, may be pre-installed on the node, or may be transferred to the node as part of the upgrade process.

In any case, an exemplary upgrade management program is configured for execution at the node to be upgraded. The upgrade management program is thus configured to read an upgrade configuration file to identify software modules needed at the node for the new software, and to initiate transfer of such software modules to the node, save configuration values associated with the old software before activating the new software at the node, and configure the node for operation with the new software using saved configuration values for data instances common to the old and new software, and using default configuration values for data instances not common to the old and new software.

Note that by determining which hew or changed software modules are needed at the node to build the new software, transfer efficiency is improved because just the needed modules are transferred to the node, and universal upgrade flexibility is gained because the determination of which modules are needed to upgrade the node is made with reference to the existing node configuration. Thus, the same upgrade management program automatically tailors the upgrade process to the particulars of the node it is running on, and the upgrade management software thus automatically accommodates differing versions of node software.

The same upgrade flexibility holds true with respect to configuring the node for operation with the new software. Because wireless network nodes typically include a number of node-specific configuration values, e.g., the number and type of radio channels to be used, neighbor lists, etc., significant labor investments are lost if such nodes are upgraded without carrying over prior configuration information. To the extent such prior configuration information is appropriate for the new software, the present invention provides an upgrade method whereby such information is automatically carried forward into the new software. Where prior configuration is not appropriate for reuse in the new software, the present invention provides default configuration information.

Thus, present invention provides a method of upgrading from old software to new software at a node in a wireless communication network comprising saving attribute values for data instances existent in the old software before activating the new software at the node, identifying data instances in the new software having corresponding data instances in the old software. Once the snapshot is saved, and the new software is activated at the node, the method configures attribute values of said identified data instances in the new software using the attribute values saved for the corresponding data instances in the old software, and configuring attribute values of any remaining data instances in the new software using default configuration values. Such data instances may comprise instantiations of managed objects as defined by the old and new software.

Identifying data instances in the new software having corresponding data instances in the old software can be based on comparing a first list of data instances existent in the new software to a second list of data instances existent in the old software to identify which data instances in the new software have corresponding data instances in the old software. In an exemplary embodiment, the first list is included in an upgrade configuration file, which may also identify all the software modules needed to build the new software at the node. The upgrade management program generally obtains or generates the second list using an information management database at the node, which contains information about the software structures existing in the old (current) software running at the node, and which further includes configured attribute values associated with those structures.

Thus, an exemplary upgrade management program is pre-loaded at the node, or transferred to the node as needed, to carry out the upgrade process. That exemplary program is configured to read an upgrade configuration file to identify software modules needed at the node for the new software, and to initiate transfer of such software modules to the node, save configuration values associated with the old software before activating the new software at the node, and configure the node for operation with the new software using saved configuration values for data instances common to the old and new software, and using default configuration values for data instances not common to the old and new software.

As noted, the upgrade management program may identify data instances common to the old and new software by comparing a first listing of data instances existing in the new software, which listing may be included in the upgrade configuration file, to a second listing of data instances existing in the old software, which may be identified by an existing information management database at the node. Similarly, the upgrade management software may identify which software elements are changed or added in the new software versus those elements preexisting at the node in the old software, and thereby determine which elements need to be transferred to the node.

As such, the upgrade management program and, in general, the universal upgrade method of the present invention, should be understood as a flexible approach to upgrading nodes in a wireless communication network that automatically adapts the upgrade process to the needs of each node. This ability is illustrated by the exemplary embodiments disclosed in the following detailed discussion, and those skilled in the art will recognize additional features and advantages of the present invention upon reading that discussion, and upon viewing the accompanying figures.

### BRIEF DESCRIPTION OF THE DRAWINGS

FIG. 1 is a diagram of an exemplary wireless communication network according to the present invention.

FIG. 2 is a diagram of an exemplary upgrade management program according to the present invention.

FIG. 3 is a diagram of exemplary processing logic for upgrading node software according to the present invention.

FIG. 4 is a diagram of old versus new node configurations, as effected by exemplary operation of the upgrade management program of FIG. 2.

FIG. 5 is an illustration of carrying forward existing node configuration information for one or more data instances common between the old and new software at the node, and one or more data instances not common between the old and new software.

FIGS. 6-8 are illustrations of exemplary processing logic details for the upgrade method of FIG. 3.

### DETAILED DESCRIPTION OF THE INVENTION

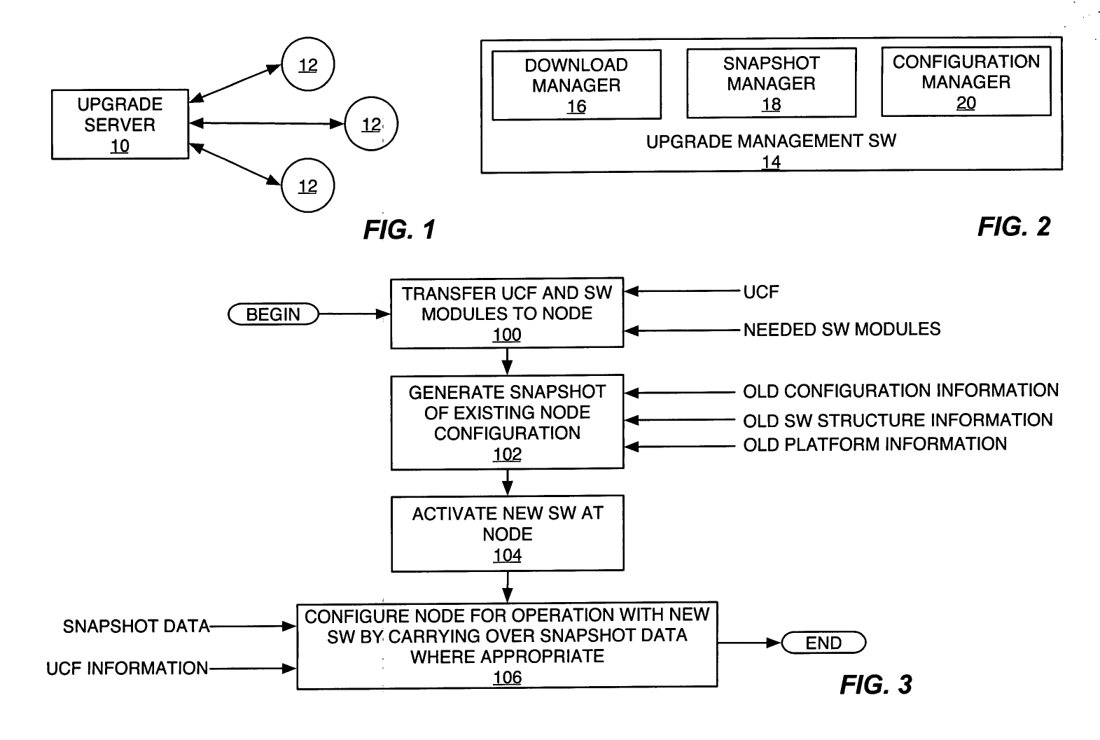

FIG. 1 is a diagram of an exemplary wireless communication network simplified for clarity of discussion in the context of the present invention. Thus, while many network entities are not illustrated in FIG. 1, it should be understood that the network may comprise a cellular communication network based on cdma2000 standards, Wideband CDMA standards, GSM standards, etc.

For purposes of this discussion, then, the network comprises an upgrade server 10 and a number of distributed nodes 12 to be upgraded. Note that all nodes are assigned the same reference number, but it should be understood that different types of nodes may be involved, with each type of node being targeted for particular software upgrade, e.g., all Radio Base Stations (RBSs) upgraded to new RBS software, all Base Station Controllers (BSCs) upgraded to new BSC software, etc. In general, nodes 12 may comprise any mix of RBSs, BSCs, Mobile Switching Centers (MSCs), Packet Control Functions (PCFs), Packet Data Serving Nodes (PDSNs), etc., or any mix thereof.

Regardless of the particular type of node(s) being upgraded, the present invention broadly comprises a method of upgrading from old software to new software at a node in a wireless communication network. The exemplary method is based on receiving an upgrade configuration file at the node that includes default configuration values for the new software and a list of software modules comprising the new software, initiating transfer of software modules needed at the node for the new software based on the list, saving snapshot data representing the existing node configuration for the old software and then activating the new software at the node, and configuring the node for operation with the new software by carrying forward actual configuration values saved in the snapshot data where appropriate, and otherwise by using default configuration values from the upgrade configuration file.

Initiating transfer of software modules needed at the node for the new software based on the list may be based on comparing a list of software modules existent at the node to the list included in the upgraded configuration file to identify software modules that are new or changed, and initiating transfer of the new or changed software modules to the node. Further, saving snapshot data representing the existing node configuration for the old software and then activating the new software at the node may be based on saving a listing of data instances existent in the old software and saving corresponding attribute values for those data instances.

Note that the above exemplary method steps make the underlying upgrade process essentially independent of the differences between the old and new software at the node. This independence arises because the upgrade method automatically accommodates version variations by using old versus new software module listings to identify the particular software components needed to build the new software at each particular node.

Similarly, the exemplary upgrade process automatically preserves existing node configuration data, where such preservation is appropriate, by identifying data instances common to the old and new software. Specifically, the exemplary method configures the node for operation with the new software by carrying forward actual configuration values saved in the snapshot data where appropriate, and otherwise by using default configuration values from the upgrade configuration file. To effect this step, the method identifies data instances existent in the new software that have corresponding data instances in the old software, and configures those data instances using the saved attribute values, and configures remaining data instances in the new software using default configuration values from the upgrade configuration file.

Saving snapshot data representing the existing node configuration for the old software and then activating the new software at the node may comprise saving a list of managed object instances in the old software, along with saving actual configuration values for those managed object instances. Thus, the method may configure managed object instances in the new software using either actual configuration values from the saved snapshot data or default configuration values from the upgrade configuration file depending on whether a given managed object instance in the new software has a corresponding managed object instance in the old software. Further complementing the ability to reuse existing configuration values, the upgrade management program may be configured to translate between old and new data types, e.g., text strings to numerical values, or vice versa.

FIG. 2 illustrates an exemplary upgrade management program 14 for carrying out the above exemplary method of upgrading nodes 12 in the wireless communication network. The illustrated program 14 comprises a download manager 16, a snapshot manager 18, and a configuration manager 20. The program 14 is already installed at nodes 12 to be upgraded, or is transferred to them as needed to carry out the node upgrade process.

The program 14 is executed at each node 12 to be upgraded and FIG. 3 illustrates exemplary processing carried out by program 14. Once running at a given node 12, program 14 initiates transfer of an upgrade configuration file to the node, which it uses to identify software modules needed at the node for the upgrade, which are then also transferred to the node (Step 100).

Processing continues with the program 14 saving a snapshot of the existing node configuration (Step 102). This snapshot can comprise existing (old) configuration information, old software structure information, and old software platform information, as needed. To aid the snapshot capture, the program 14 may include program instructions enabling the program 14 to read, or otherwise query, an information management database existing at the node. Such databases are commonly used at nodes 12, and they typically include listings of data instances existent in the current (old) node software, and further include configured attribute values for those data instances.

In this context, the term “data instances” should be broadly construed as any type of data structure instantiated in the software. A “managed object” instance would thus be an example of a data instance.

In wireless networks, the kinds of managed objects used at a given node 12 vary depending on the particular type of node. For example, the managed objects defined in RBS software may include radio channels, neighbor lists, etc. By way of non-limiting examples, at an RBS node, the defined managed objects might include a “Radio Channel” managed object having attributes “Channel Frequency” of type Integer data, and “Channel Class” of type Character data, and a “RBS Model” managed object having attributes “Name” of String data type, “Location” of String data type, and “Capacity” of Integer data type.

One managed object can have multiple “instances” at a node 12, such as where a RBS node uses multiple radio channels, each represented by an appropriately configured Radio Channel managed object instance. More generally, as is well understood by those skilled in the art of object-based programming, objects generally include data structures, operators, and data items, and the instantiation of a given type of object involves the creation of a specific object instance of that defined object type.

Thus, in capturing a snapshot of the existing node configuration, the program 14 may identify all managed object instances existent in the old software, and save a listing of all such instances as part of the snapshot, along with the configured attribute values of those managed object instances. Once the snapshot information is captured, program 14 activates the new software at the node 12, which may be accomplished by marking the software modules comprising the new software for execution and restarting the node 12.

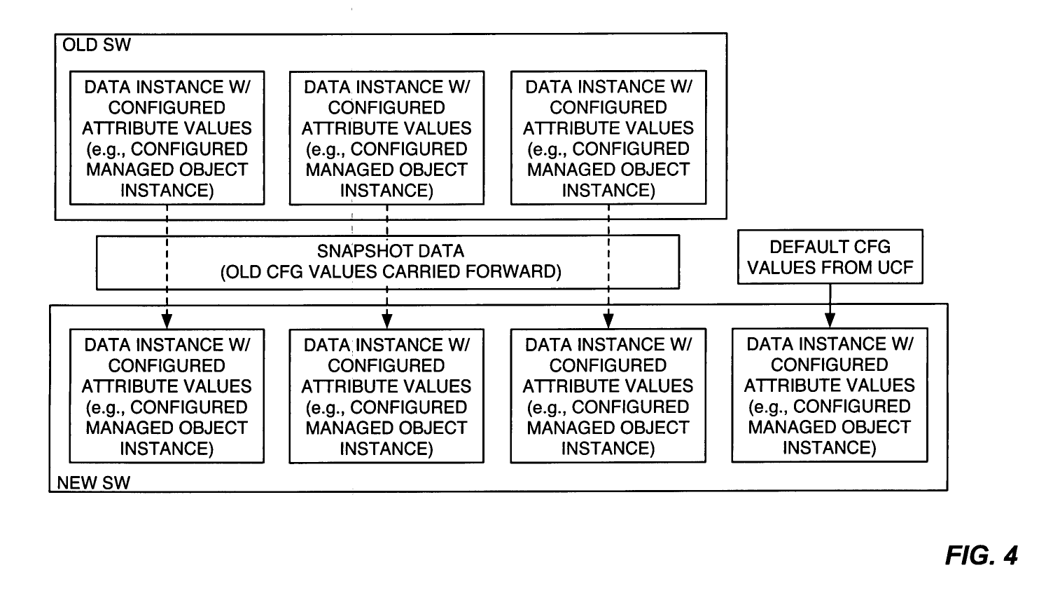

Once the new software is activated at the node 12, the program 14 configures the node 12 for operation with the new software. In accordance with the present invention, such configuration processing automatically carries over existing node configuration information where appropriate, and uses default configuration information where such carry-over information is not appropriate. In that sense, then, the existing node configuration is preserved to the extent applicable in the context of the new software. FIG. 4 illustrates an exemplary embodiment of the carrying-forward process.

As may be seen in the diagram, data instances, e.g., managed objects, in the new software have their attribute values configured using actual attribute values from corresponding data instances in the old software as saved in the snapshot data. For data instances in the new software having no corresponding data instances in the old software, and therefore having no applicable saved configuration data in the snapshot, program 14 uses default configuration information. In one or more exemplary embodiments, the upgrade configuration file includes a listing of all possible data instances-managed objects-defined for the new software, and further includes default configuration values for each such data instance to be used in the absence of carry-over configuration information.

Of further note with respect to operation of the present invention in the context of FIG. 4, attributes in the snapshot data that are obsolete in the new software are “ignored” by the upgrade method. Thus, the node upgrade method effectively “filters” the snapshot data to cleanup, i.e., remove, discard, or otherwise ignore, managed object attributes or other node configuration data that are not used in the new software. Thus, where FIG. 4 illustrates the “carrying forward” of prior configuration information, it should be understood that such carrying forward

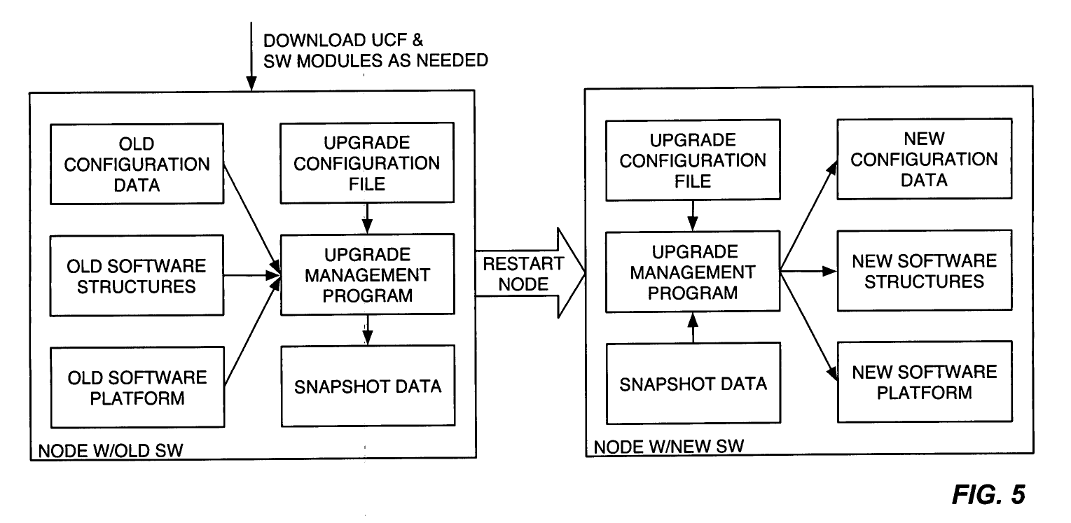

FIG. 5 illustrates the exemplary effects of node upgrading according to the present invention, and particularly in accordance with the processing logic described above. Prior to upgrading, a given node 12 operates under control of old software and according to specific configuration information, also referred to as “provisioning” information. Thus, before upgrading, the node 12 comprises the old software platform, the old software structures, the old configuration data.

The program 14, which may be preexisting at node 12, or which may be specially loaded onto node 12 as part of the upgrade process, receives a configuration file, which it uses to transfer any software modules to the node 12 that are needed by the new software. The program 14 then generates the snapshot data, marks the software modules comprising the new software for execution, and restarts the node 12.

Program 14 then initializes/configures the software structures and other configurable elements using carried-over configuration information were appropriate, i.e., old configuration information from the snapshot data, and using default configuration information from the upgrade configuration file where appropriate. Upon completion of the upgrade process, the node 12 operates under control of the new software and comprises the new software platform, the new software structures, and the new configuration data, which, as just noted, may comprise a mix of carried-over and default configuration data.

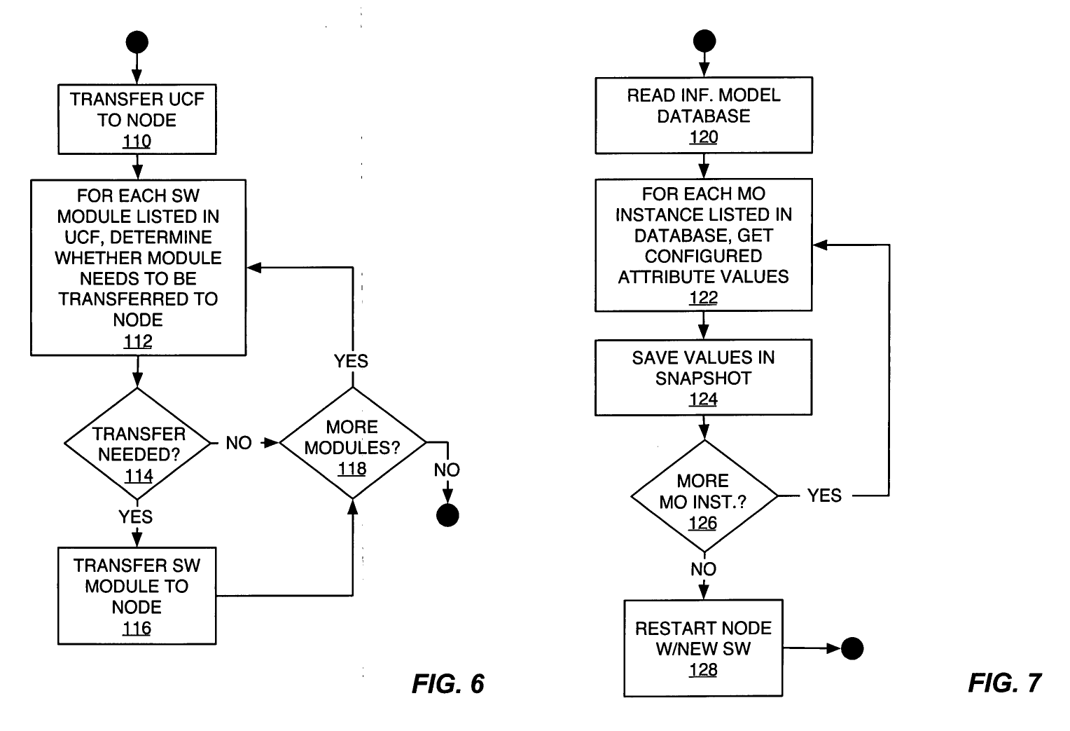

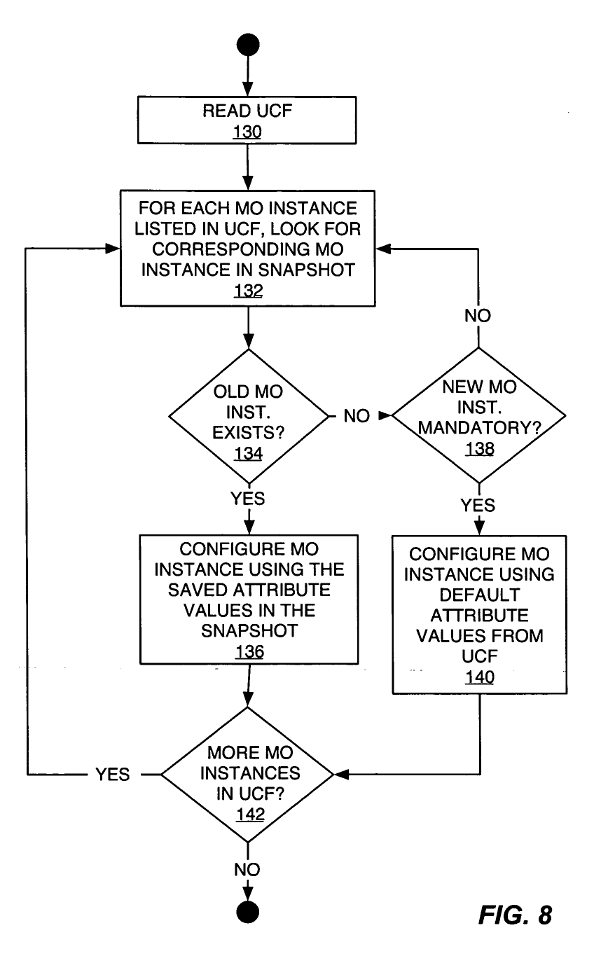

FIGS. 6-8 illustrate exemplary details corresponding to the above node upgrade method, and provide an opportunity to discuss additional features and advantages of the present invention. FIG. 6 in particular illustrates exemplary download management details, FIG. 7 illustrates exemplary snapshot generation details, and FIG. 8 illustrates exemplary new software configuration details. The following sections treat each illustration in turn.

According to FIG. 6, the upgrade configuration file is transferred to a node 12 having the upgrade management program described herein (Step 110). The exemplary upgrade configuration file includes a first listing that identifies all software modules comprising the new software, and/or lists all components, libraries, objects, etc., in the new software. For each such listed item, the program 14 determines whether the correct version of the listed item is already available at the node 12, in which case it does not need to be transferred, or whether it is missing or outdated, in which case it does need to be transferred (Step 112). Preferably, only the needed items are transferred, thus minimizing the amount of data transported from the server 10 (or other network entity) to the node 12 being upgraded.

Specifically, the program 14 may compare the upgrade configuration file listing of software modules comprising the new software to an information management database listing of software modules comprising the old software to identify whether a transfer is needed for each listed module (Step 114). If so, the needed module is transferred to the node (Step 116). If there are more listed modules to check (Step 118), processing continues until the list is completely processed, and all software components needed for the new software have been transferred to the node 12.

Of course, it should be understood that the present invention also contemplates simply sending the needed software modules/elements to all nodes 12 being upgraded, thereby obviating the need for comparing the old versus new software listings, and also simplifying the contents of the upgrade configuration file. Such an approach may be particularly attractive where there are no bandwidth concerns regarding communications between the server 10 and nodes 12, or where the upgrade comprises a small amount of data in all cases.

In any case, once the download/transfer process is complete, upgrade processing turns to generation of the snapshot data and FIG. 7 provides an exemplary illustration of such processing. Exemplary snapshot processing begins with the program 14 reading an information model database that describes the collection of data instances, e.g., managed objects, existent in the old software (Step 120). For each managed object instance, the program 14 gets the corresponding configuration values, e.g., the managed object instance's attribute values as configured in the existing software (Step 122), and saves those values in the snapshot (Step 124).

If there are more managed object instances (Step 126), the process repeats. Otherwise, once all the configuration data is saved, the program 14 marks the new software for execution, and restarts the node 12 to make that new software active (Step 128).

Processing then continues with configuring the node 12 for operation with the new software, as illustrated by FIG. 8. Once the new software is started, the program 14 reads the upgrade configuration file to obtain a listing of data instances used in the new software (Step 130). For each data instance listed, the program 14 configures that data instance's attributes using either saved snapshot data, or default configuration data.

That configuration process is accomplished by comparing the data instance listing in the upgrade configuration file to the data instance listing as saved in the snapshot. More particularly, for each data instance listed in the upgrade configuration file, the program 14 determines whether a corresponding data instance existed in the old software, i.e., it determines whether each listed data instance has a corresponding data instance in the snapshot listing (Step 132).

If a corresponding data instance existed in the old software (Step 134), program 14 configures the new data instance using the configuration values (attribute values) saved in the snapshot for that old data instance (Step 136). On the other hand, if there is no corresponding data instance, program 14 determines whether the new data instance is mandatory, i.e., must be included in the new software. If not, processing continues by repeating the comparison process for the next data instance listed in the upgrade configuration file. If the listed data instance is mandatory, i.e., it must be implemented and configured in the new software, program 14 retrieves default configuration values provided in the upgrade configuration file for that type of data instance (Step 140). This configuration processing continues for all data instances listed in the upgrade configuration file.

Once the configuration processing is complete, the new software at the node is fully configured and the node generally is ready for operation in the network. Note that the above processing preserves the labor and knowledge investment represented by the node-specific configuration values embodied in the old node software by carrying forward such items of the old configuration as are appropriate for use in the new software.

The overall upgrade processing method, and particularly the carryover of prior configuration values, may be aided by the adoption of uniform, flexible file formats. For example, regardless of the differences between the old and new software versions, or differences between old and new software platforms, program 14 may be configured to use a standardized file format for its upgrade configuration file and/or for its snapshot data. In an exemplary embodiment, the upgrade configuration file is an extensible Markup Language (XML) file that includes meta-tags defining all possible managed object types used by the new software, and all instantiations of those objects, along with the default configuration values to be used for them if snapshot data is not available or is not appropriate for configuration use.

Further, the snapshot data listing all managed object instances and corresponding attribute values as used in the old software also may be in an XML format, and that format may be used independently of the old version of software running at the node, since the program 14 preferably is configured to generate its own snapshot of the old node configuration and software based on its reading of one or more existing databases at the node.

Additionally, as noted earlier herein, program-14 can be configured to provide automatic translation between data types used for managed object attributes in the old software versus data types used for like managed object attributes in the new software. That is, there may be cases where the property of an attribute might have changed across old and new software versions.

By way of non-limiting example, assume that one of two RBS nodes 12 currently runs Version A of the old software, and the other one runs Version B of the old software. Both the Version A node and the Version B node are to be upgraded to Version C of the software. For a given managed object type in Version A, the attribute “Frequency Type” does not exist, in Version B that attribute exists as a text string, and in Version C it exists as an integer. Note that the information model database at each of the Version A and Version B RBS nodes would indicate the existence and type of such attributes, and thus such information would be known to program 14.

While upgrading from A to C, program 14 determines that the Frequency Type attribute did not exist in the old software, and thus would configure managed object instances having that attribute using one or more default values provided by the upgrade configuration file. However, when upgrading from B to C, program 14 finds a string value for the Frequency Type attribute in the snapshot. As program 14 knows (from the upgrade configuration file) that same attribute is an integer in Version C of the software, it converts the snapshot string into a corresponding integer for use in configuring the node with Version C of the software.

Thus, the universality of the software upgrade method disclosed herein is further enhanced by the ability to carry forward applicable prior configuration settings, even if the data types of such settings have changed in the old and new software. Indeed, because of the present invention's method of software upgrading, which transfers software as needed to the node, captures snapshot data for the existing node configuration, and then uses an upgrade configuration file to identify which prior configuration information should be (or can be) carried forward to the new software, the upgrade process adapts to the individual needs/differences at each node.

Thus, the present invention broadly contemplates a software upgrade process that is particularly advantageous in wireless communication network environments, where individual nodes may run different versions of old software, and wherein the preservation of existing node configuration may be of significant value. As such, the present invention is not limited by the foregoing details, but rather is limited only by the following claims and their reasonable equivalents.

What is claimed is:

1. A method of upgrading from old software to new software at a node in a wireless communication network comprising:
receiving an upgrade configuration file at the node that includes default configuration values for the new software and a list of software modules comprising the new software;
initiating transfer of software modules needed at the node for the new software based on the list;
saving snapshot data representing the existing node configuration for the old software and then activating the new software at the node; and
configuring the node for operation with the new software by carrying forward actual configuration values saved in the snapshot data where appropriate, and otherwise by using default configuration values from the upgrade configuration file.

2. The method of claim 1, wherein initiating transfer of software modules needed at the node for the new software based on the list comprises comparing a list of software modules existent at the node to the list included in the upgraded configuration file to identify software modules that are new or changed, and initiating transfer of the new or changed software modules to the node.

3. The method of claim 1, wherein saving snapshot data representing the existing node configuration for the old software and then activating the new software at the node comprises saving a listing of data instances existent in the old software and saving corresponding attribute values for those data instances.

4. The method of claim 3, wherein configuring the node for operation with the new software by carrying forward actual configuration values saved in the snapshot data where appropriate, and otherwise by using default configuration values from the upgrade configuration file comprises identifying data instances existent in the new software that have corresponding data instances in the old software, and configuring those data instances using the saved attribute values, and configuring remaining data instances in the new software using default configuration values from the upgrade configuration file.

5. The method of claim 1, wherein saving snapshot data representing the existing node configuration for the old software and then activating the new software at the node comprises saving a list of managed object instances in the old software, along with saving actual configuration values for those managed object instances.

6. The method of claim 5, wherein configuring the node for operation with the new software by carrying forward actual configuration values saved in the snapshot data where appropriate, and otherwise by using default configuration values from the upgrade configuration file comprises configuring managed object instances in the new software using either actual configuration values from the saved snapshot data or default configuration values from the upgrade configuration file depending on whether a given managed object instance in the new software has a corresponding managed object instance in the old software.

7. The method of claim 1, further comprising translating from an old data type to a new data type for actual configuration values carried forward from the saved snapshot data where configuration value data types have changed between the old and new software.

8. The method of claim 1, wherein activating the new software at the node comprises marking the software modules comprising the new software for execution, and then restarting the node.

9. A computer readable medium storing a computer program for upgrading from old software to new software at a node in a wireless communication network, said computer program comprising:
program instructions to receive an upgrade configuration file at the node that includes default configuration values for the new software and a list of software modules comprising the new software;
program instructions to initiate transfer of software modules needed at the node for the new software based on the list;
program instructions to save snapshot data representing the existing node configuration for the old software and then activate the new software at the node; and
program instructions to configure the node for operation with the new software by carrying forward actual configuration values saved in the snapshot data where appropriate, and otherwise by using default configuration values from the upgrade configuration file.

10. The computer readable medium storing the computer program of claim 9, wherein the program instructions to initiate transfer of software modules needed at the node for the new software based on the list comprise program instructions to compare a list of software modules existent at the node to the list included in the upgraded configuration file to identify software modules that are new or changed, and initiate transfer of the new or changed software modules to the node.

11. The computer readable medium storing the computer program of claim 9, wherein the program instructions to save snapshot data representing the existing node configuration for the old software and then activate the new software at the node comprise program instructions to save a listing of data instances existent in the old software and saving corresponding attribute values for those data instances.

12. The computer readable medium storing the computer program of claim 11, wherein the program instructions to configure the node for operation with the new software by carrying forward actual configuration values saved in the snapshot data where appropriate, and otherwise by using default configuration values from the upgrade configuration file comprise program instructions to identify data instances existent in the new software that have corresponding data instances in the old software, and configure those data instances using the saved attribute values, and configure remaining data instances in the new software using default configuration values from the upgrade configuration file.

13. The computer readable medium storing the computer program of claim 9, wherein the program instructions to save snapshot data representing the existing node configuration for the old software and then activating the new software at the node comprise program instructions to save a list of managed object instances in the old software, and to save actual configuration values for those managed object instances.

14. The computer readable medium storing the computer program of claim 13, wherein the program instructions to configure the node for operation with the new software by carrying forward actual configuration values saved in the snapshot data where appropriate, and otherwise by using default configuration values from the upgrade configuration file comprise program instructions to configure managed object instances in the new software using either actual configuration values from the saved snapshot data or default configuration values from the upgrade configuration file depending on whether a given managed object instance in the new software has a corresponding managed object instance in the old software.

15. The computer readable medium storing the computer program of claim 9, further comprising program instructions to translate from an old data type to a new data type for actual configuration values carried forward from the saved snapshot data where configuration value data types have changed between the old and new software.

16. The computer readable medium storing the computer program of claim 9, wherein the program instructions to activate the new software at the node comprise program instructions to mark the software modules comprising the new software for execution, and then restart the node.

17. A method of upgrading from old software to new software at a node in a wireless communication network comprising:
saving attribute values for data instances existent in the old software before activating the new software at the node;
identifying data instances in the new software having corresponding data instances in the old software; and
configuring attribute values of said identified data instances in the new software using the attribute values saved for the corresponding data instances in the old software, and configuring attribute values of any remaining data instances in the new software using default configuration values.

18. The method of claim 17, wherein the data instances in the old software and in the new software comprise instantiations of managed objects as defined by the old and new software.

19. The method of claim 17, wherein identifying data instances in the new software having corresponding data instances in the old software comprises comparing a first list of data instances existent in the new software to a second list of data instances existent in the old software to identify which data instances in the new software have corresponding data instances in the old software.

20. A method of upgrading from old software to new software at a node in a wireless communication network comprising executing an upgrade management program at the node that is configured to:
read an upgrade configuration file to identify software modules needed at the node for the new software, and to initiate transfer of such software modules to the node;
save configuration values associated with the old software before activating the new software at the node; and
configure the node for operation with the new software using saved configuration values for data instances common to the old and new software, and using default configuration values for data instances not common to the old and new software.

21. The method of claim 20, wherein the upgrade manager program is configured to identify data instances common to the old and new software by comparing a first listing of data instances existing in the new software to a second listing of data instances existing in the old software.

22. The method of claim 21, wherein the upgrade management program is configured to read the first listing from the upgrade configuration file.

23. The method of claim 21, wherein the upgrade manager program is configured to generate the second listing of data instances before activating the new software at the node by querying an information management database stored at the node.

24. The method of claim 20, wherein the data instances existing in the old software and in the new software comprise instances of managed objects respectively defined in the old and new software.

25. The method of claim 20, wherein the upgrade management program is configured to obtain the default configuration values from the upgrade configuration file.
